(19) United States
(12) Patent Application Publication
(10) Pub. No.: US 2013/0092131 A1
(43) Pub. Date: Apr. 18, 2013

(54) INLET CONNECTOR

(71) Applicant: Christian Graspeuntner, Hallein (AT)

(72) Inventor: Christian Graspeuntner, Hallein (AT)

(73) Assignee: Robert Bosch GmbH, Stuttgart-Feuerbach (DE)

(21) Appl. No.: 13/805,954

(22) PCT Filed: Jun. 21, 2011
(86) PCT No.: PCT/AT11/00272

§ 371 Date: Dec. 20, 2012

(30) Foreign Application Priority Data
Jun. 22, 2010 (AT) A 1035/2010

(51) Int. Cl. F02M 69/46

(52) U.S. Cl. CPC F02M 69/46
USPC 123/456

(57) ABSTRACT

In an inlet connector (4) for connecting at least one high-pressure line of a common-rail injection system to an inlet bore (6) of a fuel injector, a pressure pipe (7) connectable to the inlet bore (6) and a housing (8) including a connection for the at least one high-pressure line are connected to each other so as to form a sliding seat.

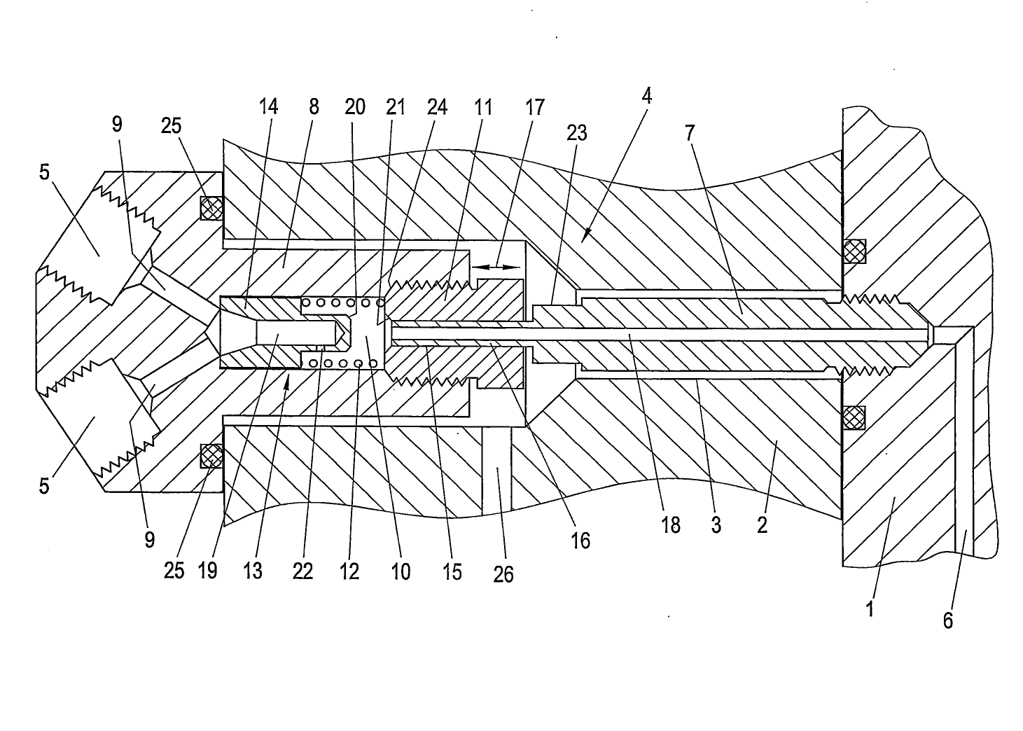

The invention relates to an inlet connector for connecting at least one high-pressure line of a common-rail injection system to an inlet bore of a fuel injector. The invention further relates to an internal combustion engine having a common-rail injection system including a high-pressure storage (common rail), at least one injector fixed in a cylinder head for injecting fuel into a combustion chamber of the internal combustion engine, and at least one high-pressure line fed by the high-pressure storage.

Modern diesel engines with common-rail technology comprise an inlet connector as an intermediate member between the fuel injector and the high-pressure fuel line to connect the two components. The inlet connector has to be sealed relative to the injector. The inlet connector, which is traversed by a passage bore in its longitudinal direction, as a rule is disposed in a bore that extends transversely through the cylinder head, starting from a longitudinal side of the cylinder head and leading to a connection on the injector. In order to establish a pressure-tight connection between the inlet connector and the injector body, the inlet connector is usually pressurized against the injector body via an element building up a press-in pressure, whereby a cone disposed on the inlet connector on the side of the injector is pressed into an accordingly conical recess provided on the connection of the injector.

In doing so, the high-pressure line is braced against the inlet connector end facing away from the injector and projecting out of the cylinder head, by the aid of a retaining screw encompassing a connecting piece provided on the high-pressure line and screwed into the transverse bore provided in the cylinder head and receiving the inlet connector, thus pressing the inlet connector axially against a seat provided on the injector body and defining the feed channel. Such a construction, however, involves the drawback that variations in the axial sealing force of the connection of the inlet connector at the feed line of the injector, which sealing force depends on the torque of the retaining screw, leads to strong variations in the admissible compression pulsating fatigue strength. Another drawback consists in that the biasing force on said high-pressure connection is subject to variations resulting from different thermal expansions of the inlet connector and the cylinder head.

EP 2 058 509 A1, EP 1 719 899 A1 and EP 1 653 076 A1 disclose prior art inlet connectors in which the above-mentioned problem occurs.

The present invention, therefore, aims to further develop an inlet connector of the initially defined kind to the effect that the biasing force or the press-in pressure of the inlet connector on the connection of the inlet bore of the injector is independent of the connection situation on the opposite end of the inlet connector, i.e. the connection situation of the high-pressure line.

To solve this object, an inlet connector of the initially defined kind according to a first aspect of the invention is characterized in that a pressure pipe connectable to the inlet bore and a housing comprising a connection for the at least one high-pressure line are connected to each other so as to form a sliding seat. To solve this object, the invention according to a further aspect provides an internal combustion engine having a common-rail injection system including a high-pressure storage (common rail), at least one injector fixed in a cylinder head for injecting fuel into a combustion chamber of the internal combustion engine, and at least one high-pressure line fed by the high-pressure storage, which is further developed such that the at least one high-pressure line is connected to an inlet bore of the injector via an inlet connector according to the invention, said inlet connector traversing a transverse bore of the cylinder head.

In that the inlet connector comprises two parts, namely the pressure pipe connectable to the inlet bore of the injector and the housing comprising a connection for the at least one high-pressure line, which are connected to each other by the aid of a sliding seat, the advantage has been achieved that the pressure pipe is separated from the housing in the axial direction such that the connections provided on the two ends of the inlet connector, namely the connection of the pressure pipe to the inlet bore of the injector and the connection of the high-pressure line to the housing, also have to be realized to be isolated from each other, with the biasing forces applied on the respective connection and the respectively applied press-in or application pressures coming into effect independently of one another.

It is thereby, in particular, possible to provide extremely secure mounting of the pressure pipe with the appropriate tightening moment. In this context a preferred configuration provides that the pressure pipe is screwed into the injector body for connection to the inlet bore of the injector.

The housing can, in particular, be decoupled from the pressure pipe in that the housing comprises a flange including bores for fastening the housing to the cylinder head, as in correspondence with a preferred configuration. Such decoupling will, moreover, result in very good vibration damping, since possible vibrations will be less strongly transmitted to the pressure pipe on account of the connection of the housing to the pressure pipe via said sliding seat.

As another advantage of the invention, it is to be mentioned that the high biasing forces allow for the safe mounting of the high-pressure lines without entailing the risk of a detachment of the pressure pipe, or a displacement of the housing within the cylinder head. Due to the sliding seat, a longitudinal compensation following different thermal expansions will be readily feasible without any loss of the biasing force on the pressure pipe.

The sliding seat in a preferred manner comprises two substantially sealingly cooperating cylindrical sealing surfaces. Sealing in this case is, in particular, effected by selecting a very small radial play between the mutually cooperating sealing surfaces, a radial play of a few micrometers being preferred. Sealing between the pressure pipe and the housing is, moreover, promoted by a large contact length on the sliding seat. The configuration in this respect is preferably further devised such that the cylindrical sealing surfaces are formed by the outer shell of a portion of the pressure pipe, or housing, that is designed with a reduced outer diameter and by the inner surface of a bore that is formed in the respective other part.

The tightness of the connection realized by the sliding seat can even be further increased in that the radial play between the pressure pipe and the housing is further reduced and, in particular, almost eliminated under the action of the fuel pressure. The leakages occurring because of the annular gap can thus be minimized. In order to utilize the system pressure for reducing the radial play, it is provided by a preferred further development that the wall thickness of the portion of the pressure pipe that is designed with a reduced outer diameter is configured to be smaller than in the remaining portion of the pressure pipe. Due to the small wall thickness, the portion of the pressure pipe formed with a smaller outer diameter is able to expand in the radial direction so as to cause the sealing surface of the pressure pipe to be pressed against the sealing surface of the housing. In this context, a configuration in which the wall thickness of the portion of the pressure pipe that is designed with a reduced outer diameter amounts to between 30 and 70% of the inner diameter in said portion will be of particular advantage.

In order to achieve an additional sealing on the sliding seat, a sealing element such as, for instance, a PEEK ring or hydraulic sealing packages known from the prior art, can be additionally inserted.

Possible leakages may preferably be drained via a leakage outlet bore. The invention in this respect is preferably further developed such that a leakage outlet bore leads away from the transverse bore of the cylinder head, preferably in the region of the sliding seat of the inlet connector.

In order to ensure sealing between the housing of the inlet connector and the cylinder head, it is preferably provided that a portion overlapping the edge of the transverse bore of the cylinder head, in particular the flange of the housing of the inlet connector, abuts on the cylinder head via an interposed sealing element.

Inlet connectors of the initially described type, as a rule, comprise flow limiters. In a preferred further development of the invention, the flow limiter is disposed in the housing of the inlet connector. In order to facilitate the installation of the flow limiter, a preferred further development, moreover, provides that the bore receiving the portion of the pressure pipe designed with a reduced outer diameter is formed in an insert that is screwed into the housing. The insert that is screwed into the housing will thus define a cavity formed within the housing and in which the flow limiter is disposed.

Further preferred configurations can be taken from the dependent claims.

In the following, the invention will be explained in more detail by way of an exemplary embodiment schematically illustrated in the drawing. Therein, the injector body of an injector not illustrated in detail is denoted by 1. The cylinder head is denoted by 2 and comprises a transverse bore 3, which is traversed by an inlet connector 4. The inlet connector 4 connects high-pressure lines (not illustrated in detail) to be connected to high-pressure connections 5 with the inlet bore 6 formed in the injector body 1 to supply high-pressure fuel to the injector nozzle. The inlet connector 4 is comprised of a pressure pipe 7 and a housing 8. For the passage of the high-pressure fuel, the housing 8 comprises bores 9 each leading obliquely away from the high-pressure connections 5 and opening into a cylindrical space 10 within the housing 8. The cylindrical space 10 is defined by an insert 11 that is screwed into the housing 8 and on whose annular end face a compression spring 12 of a flow limiter 13 is supported. The actuator of the flow limiter 13, which is displaceable in the axial direction, is denoted by 14.

The insert piece 11 comprises a central bore 15 into which a portion 16 of the pressure pipe 7 plunges, which portion is designed to have a reduced outer diameter. The portion 16 designed to have a reduced outer diameter, of the pressure pipe 7 and the insert 11 of the housing 8 comprise mutually cooperating, cylindrical sealing surfaces that are freely movable relative to each other in the sense of double arrow 17. The sealing surfaces thus form a sliding seat that establishes the connection between the housing 8 and the pressure pipe 7. The cylindrical space 10 of the housing 8 is connected to the inlet line 6 via a central bore 18 formed in the pressure pipe 7.

The actuator 14 of the flow limiter 13 comprises a blind hole 19 and is axially displaceably guided in the cylindrical space 10. The actuator 14 comprises a conical transition surface 20 between its cylindrical peripheral surface and its closed end wall, with which it forms a valve sealing surface cooperating with a valve seat 21 formed on a conical cross-sectional transition between the cylindrical space 10 and the bore 18. The blind hole 19 is connected to the cylindrical space 10 via at least one throttle bore 22. Via said throttle bore 22, fuel will flow from the blind hole 19 into the space 10, and from there into the adjoining bore 18, with the actuator 14 lifted off the valve seat 21. The compression spring 12 is configured such that the actuator 14 is held in the illustrated, open position at a pregiven pressure difference between the high-pressure lines not illustrated and the inlet bore 6. However, as soon as said pregiven pressure difference is exceeded, for instance due to a broken line and the accordingly uncontrolled flow of fuel out of said line, the actuator 14 is displaced into the closed position against the force of the compression spring 12, in which closed position the conical valve surface 20 is pressed against the seat surface 21 to stop the continued flow of fuel.

The installation of the inlet connector is performed in a manner that, at first, the pressure pipe 7 is guided through the cylinder head 2 and screwed into the injector body 1 by the aid of a tool engaging at the hexagon 23. By selecting an appropriate tightening moment, the pressure pipe 7 can thus be securely mounted. The housing 4 is premounted, the premounted unit comprising the actuator 14 of the flow limiter 13, the compression spring 12 and the insert piece 11. The insert piece 11 is screwed into the housing 8 by a thread, with a suitable high-pressure seal being achieved due to the mutually cooperating conical sealing surfaces 24. The premounted unit is connected to the pressure pipe 7 via the sliding seat. After this, the housing 8 is fastened to the cylinder head 2 by the aid of a flange (not illustrated in detail) and by screws, wherein the biasing force is so high that the tightening moment used to connect the high-pressure line to the high-pressure connections 5 can be taken up with sufficient safety. The housing 8 is additionally positioned by the aid of pins passing through oblong holes in order to prevent lateral position deviations.

The housing 8 is sealed against the cylinder head 1 by sealing means 25. Occurring leakages are discharged via a leakage discharge bore 26. The inlet connector 4 is received in the transverse bore 3 of the cylinder head 2 with radial play over its entire length such that height tolerances between the injector and the cylinder head will be compensated for.

1. An inlet connector for connecting at least one high-pressure line of a common-rail injection system to an inlet bore of a fuel injector, characterized in that a pressure pipe (7) connectable to the inlet bore (6) and a housing (8) comprising a connection (5) for the at least one high-pressure line are connected to each other so as to form a sliding seat.

2. An inlet connector according to claim 1, characterized in that the sliding seat comprises two substantially sealingly cooperating cylindrical sealing surfaces.

3. An inlet connector according to claim 2, characterized in that the pressure pipe (7) and the housing (8) are freely movable relative to each other in the axial direction along the cylindrical sealing surfaces.

4. An inlet connector according to claim 2, characterized in that the cylindrical sealing surfaces are formed by the outer shell of a portion (16) of the pressure pipe (7), or housing (8), that is designed with a reduced outer diameter and by the inner surface of a bore that is formed in the respectively other part.

5. An inlet connector according to claim 4, characterized in that the wall thickness of the portion (16) of the pressure pipe (7) that is designed with a reduced outer diameter is configured to be smaller than in the remaining portion of the pressure pipe (7).

6. An inlet connector according to claim 4, characterized in that the wall thickness of the portion (16) of the pressure pipe (7) that is designed with a reduced outer diameter amounts to between 30 and 70% of the inner diameter in said portion.

7. An inlet connector according to claim 4, characterized in that the bore receiving the portion (16) of the pressure pipe that is designed with a reduced outer diameter is formed in an insert that is screwed into the housing (8).

8. An inlet connector according to claim 4, characterized in that the pressure pipe (7), on the shoulder formed by the portion (16) designed with a reduced outer diameter, has a non-circular cross section, in particular a hexagonal section (23), for the application of a screwing tool.

9. An inlet connector according to claim 1, characterized in that the housing (8) comprises a flow limiter (13).

10. An inlet connector according to claim 1, characterized in that the housing (8) comprises a flange having bores for fastening the housing (8) to the cylinder head (2).

11. An internal combustion engine having a common-rail injection system including a high-pressure storage (common rail), at least one injector fixed in a cylinder head for injecting fuel into a combustion chamber of the internal combustion engine, and at least one high-pressure line fed by the high-pressure storage, characterized in that the at least one high-pressure line is connected to an inlet bore (6) of the injector via an inlet connector (4) according to any one of claims 1 to 10, said inlet connector (4) traversing a transverse bore (3) of the cylinder head (2).

12. An internal combustion engine according to claim 11, characterized in that the inlet connector (4) is received in the bore (3) of the cylinder head (2) with radial play.

13. An internal combustion engine according to claim 11, characterized in that a portion overlapping the edge of the transverse bore (3) of the cylinder head (2), in particular the flange of the housing (8) of the inlet connector (4), abuts on the cylinder head (2) via an interposed sealing element.

14. An internal combustion engine according to claim 11, characterized in that a leakage outlet bore leads away from the transverse bore (3) of the cylinder head (2), preferably in the region of the sliding seat of the inlet connector (4).

15. An internal combustion engine according to claim 11, characterized in that the pressure pipe (7) is screwed into the injector body (1) for connection to the inlet bore (6) of the injector.
